(19) United States
(12) Patent Application Publication
(10) Pub. No.: US 2006/0293096 A1
(43) Pub. Date: Dec. 28, 2006

(54) Hinge mechanism of folding type information processing unit

(75) Inventors: Kazuhiro Kakuguchi, Kawasaki (JP); Katsumi Takada, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/255,993

(22) Filed: Oct. 24, 2005

(30) Foreign Application Priority Data
Jun. 28, 2005 (JP) 2005-188260

(51) Int. Cl. H04M 1/00

(52) U.S. Cl. 455/575.3; 348/333.06

(57) ABSTRACT

An information processing unit such as a folding type mobile phone whose first casing having a display and second casing having buttons are connected by a hinge. A first fixing mechanism of the hinge temporarily fixes the first and the second casing by a predetermined holding force when an opening angle between the first and the second casing is a first degree of opening which is smaller than 180°. A second fixing mechanism of the hinge locks the first and the second casing by a holding force stronger than the holding force at the time of temporary fixing when the opening angle is 180°. This information processing unit can be opened from the closed state to the temporary fixed state with a light force, from the temporary fixed state to the lock state with a medium force, and can be closed from the lock state to the temporary fixed state with a heavy force.

### CROSS-REFERENCE TO RELATED APPLICATION

This application claims priority from, and incorporates by reference the entire disclosure of, Japanese Patent Application No. 2005-188260, filed on Jun. 28, 2005.

### BACKGROUND OF THE INVENTION

1. Field of the Invention

The present invention relates to a folding-type information processing unit capable of being folded at a hinge mechanism. More particularly, the present invention relates to improvements in a hinge mechanism of a folding type information processing unit such as a folding type mobile phone, the entire shape of which becomes linear when the folding type mobile phone is opened so that it can be used in the same manner as that of a flat-shaped mobile phone.

2. Description of the Related Art

Recently, communication units, into which computers are built, have been miniaturized. Therefore, it becomes possible for users to handily carry information processing devices such as mobile phones. In the early stage of developing these information processing devices, the entire shape of each information processing device is formed into a flat-shape, the length of which is predetermined. A mobile phone, which is a rod-shaped information processing unit, is composed as follows. An earphone is arranged at the uppermost portion of a casing. An information display section composed of a liquid crystal display is arranged on the lower side of the earphone. An input operating section composed of dial buttons and other functional buttons is arranged in the lower half portion of the casing. A telephone microphone is arranged in the lowermost portion of the mobile phone.

However, after the above rod-shaped mobile phone was developed, a new mobile phone has appeared, which is composed in such a manner that the casing is divided into the upper and the lower half and these halves are connected to each other by a hinge mechanism and folded. At present, this folding type mobile phone has become the most popular. The reason is that the display section and the input section can be protected when this folding type mobile phone is folded and, further, the portability of this mobile phone is excellent when this folding type mobile phone is folded. The folding type information processing unit, which is represented by the above mobile phone, is usually carried by a user under the condition that the information processing unit is folded. When the folding type information processing unit is used, it is usually opened.

Examples of the above folding type information processing unit are disclosed in the official gazettes of JP-A-2004-274319 and JP-A-2000-312249.

However, in the case of the above information processing unit, which is folded when it is not used and which is opened by a user when it is used, it is inconvenient for physically handicapped people and construction workers working in the construction sites to use the above information processing unit.

Detailed explanations will be made into this problem as follows. For example, in the case of the folding type mobile phone, it is necessary for a user to open the folded mobile phone with both hands when the mobile phone is used. Therefore, it may be difficult for a physically handicapped person to use the folding type information processing unit because the folding type information processing unit must be opened by the user when it is used. For a construction worker working in a construction site who can not use both hands because of the working environment, the folding type mobile phone is inconvenient because the mobile phone must be opened by the construction worker when it is used and, further, the mobile phone must be closed after the completion of the use of the mobile phone.

### SUMMARY OF THE INVENTION

Therefore, it is an object of the present invention to provide a folding type information processing unit having a hinge mechanism characterized in that, although it is a folding type information processing unit, the folding type information processing unit cannot be easily closed after it has been once opened, so that the folding type information processing unit can be used in the same manner as that of a rod-shaped information processing unit.

In order to accomplish the above object, the first embodiment of the present invention provides an information processing unit, which is opened from a folded state when it is used, comprising: a first and a second casing connected to each other by a hinge mechanism; a first fixing mechanism arranged in the hinge mechanism, for temporarily fixing the first and the second casing by a predetermined holding force when an opening angle formed between the first and the second casing is a predetermined angle smaller than 180°; and a second fixing mechanism arranged in the hinge mechanism, for locking the first and the second casing by a stronger holding force than the holding force of the first fixing mechanism under the condition that the opening angle formed between the first and the second casing is 180°.

The second embodiment provides an information processing unit according to the first embodiment, wherein a first operating load for opening the first and the second casing from the closed state to the temporarily fixed state is set in the hinge mechanism, and a second operating load, which is heavier than the first operating load, for opening the first and the second casing from the temporarily fixed state to the lock state is also set in the hinge mechanism.

The third embodiment provides an information processing unit according to the second embodiment, wherein a third operating load, which is heavier than the second operating load, for returning the first and the second casing from the lock state to the temporarily fixed state is set in the hinge mechanism.

The fourth embodiment provides an information processing unit according to one of the first to the third embodiment, wherein the hinge mechanism is composed so that an information display face of the first casing and an input operating face of the second casing can be positioned on the same plane when the first and the second casing are opened by the angle of 180°.

The fifth embodiment provides an information processing unit according to one of the first to the fourth embodiment, wherein the predetermined angle is 160° to 170°.

According to the information processing unit of the present invention, although it is a folding type information processing unit, after the folding type information processing unit has been once opened, it can not be simply closed. Therefore, the folding type information processing unit of the present invention can be used as it is opened in the same manner as that a rod-shaped information processing unit.

### BRIEF DESCRIPTION OF THE DRAWINGS

The present invention is illustrated by way of example in, but is not limited by, the figures of the accompanying drawings, in which like reference numerals indicate similar elements, in which:

FIG. 1A is a front view showing a state in which a mobile phone, which is an example of the information processing unit of the present invention, is folded;

FIG. 1B is a left side view of the mobile phone shown in FIG. 1A, wherein a hinge mechanism is located on the upside in the view;

FIG. 1C is a side view of the mobile phone shown in FIG. 1B, wherein the view is taken in the direction of arrow C;

FIG. 1D is a side view of the mobile phone shown in FIG. 1B showing a state in which the mobile phone is opened by the first degree of opening;

FIG. 1E is a side view of the mobile phone shown in FIG. 1B showing a state in which the mobile phone is opened by 180°;

FIG. 1F is a front view showing the mobile phone shown in FIG. 1E;

FIG. 2A is a perspective assembling view showing an example of the hinge mechanism of the mobile phone shown in FIGS. 1A to 1F;

FIG. 2B is a partially sectional view showing a structure of the lock pin shown in FIG. 1A;

FIG. 3A is a partially enlarged sectional view showing a hinge mechanism at the time when the mobile phone shown in FIGS. 1A to 1F is folded;

FIG. 3B is a partially enlarged sectional view showing a hinge mechanism in a state in which the mobile phone shown in FIGS. 1A to 1F is opened by the first degree of opening;

FIG. 3C is a partially enlarged sectional view showing a hinge mechanism in a state in which the mobile phone shown in FIGS. 1A to 1F is opened by the degree of 180°;

FIG. 4 is a perspective assembling view showing an example of the hinge mechanism of the mobile phone shown in FIGS. 1A to 1F;

FIG. 5A is a partially enlarged sectional view showing a lock release button shown in FIG. 4 in a state in which the mobile phone is closed;

FIG. 5B is a partially sectional view taken on line B-B in FIG. 5A;

FIG. 5C is a partially enlarged sectional view showing the lock release button shown in FIG. 4 in a state in which the mobile phone is completely opened; and

FIG. 5D is a partially sectional view taken on line C-C in FIG. 5.

### DESCRIPTION OF THE PREFERRED EMBODIMENTS

Referring to the accompanying drawings, a preferred embodiment of the present invention will be explained below on the basis of a specific example. In this connection, in the following explanations, a mobile phone is taken as an example of the information processing unit.

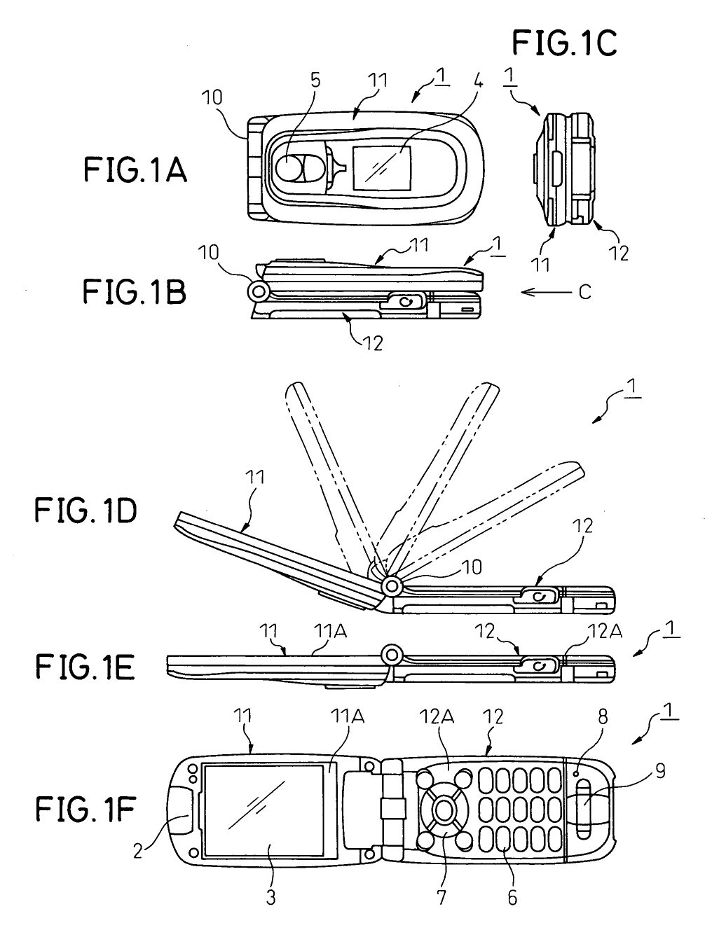

FIGS. 1A to 1F are views showing an arrangement of the example of the mobile phone 1 which is an example of the information processing unit of the present invention. FIGS. 1A to 1C are views showing a state in which the mobile phone 1 is folded. FIG. 1A is a front view, FIG. 1B is a left side view of the mobile phone 1, wherein the hinge mechanism 10 is located on the upside, and FIG. 1C is a side view of the mobile phone 1, wherein the view is taken in the direction of arrow C.

The mobile phone 1 of this embodiment is of the folding type. In this mobile phone 1, the first casing 11 having a display is connected to the second casing 12 having an input section such as dial buttons via the hinge mechanism 10. An antenna is built in the mobile phone 1 of this embodiment. On the back side of the first casing 11, the sub-display 4 and the camera 5 are provided.

FIG. 1D is a view showing a state in which the mobile phone 1 shown in FIG. 1B is opened by the first degree of opening round the hinge mechanism 10. The first degree of opening is smaller than 180°, that is, the first degree of opening is about 160°. The first operating load (the opening and closing torque) for opening and closing the mobile phone 1 between the folding state shown in FIG. 1B and the first degree of opening shown in FIG. 1D is 0.15 N-m to 0.2 N-m.

FIGS. 1E and 1F are views showing a state in which the mobile phone 1 is further opened from the state shown in FIG. 1D and an angle formed between the information display face 11A, on which the main display 3 of the first casing 11 is provided, and the input operating face 12A, on which the dial buttons 6 of the second casing 12 are provided, is made to be 180°. In this embodiment, when the first casing 11 and the second casing 12 are opened by the angle 180°, the information display face 11A and the input operating face 12A are on the same plane.

As shown in FIG. 1F, when the mobile phone 1 is opened, the first casing 11 includes a telephone earphone 2 and a main display 3, and the second casing 12 includes dial buttons 6, functional buttons 7 and a telephone microphone 8. Reference numeral 9 is a finger print sensor which is provided in the mobile phone 1 so that the mobile phone 1 can not be used by others.

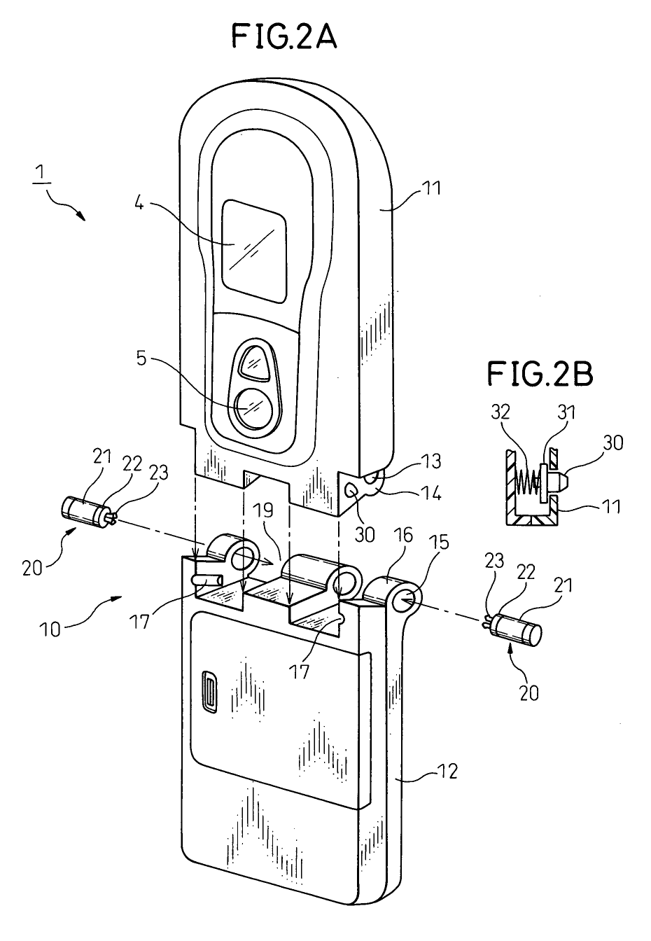

In the present invention, the second operating load, by which the mobile phone 1 is further opened from the first degree of opening shown in FIG. 1D to the state shown in FIGS. 1E and 2F, is set at a load heavier than the first operating load (0.15 N-m to 0.2 N-m), for example, the second operating load is set at an operating load two or three times as heavy as the first operating load. Further, in the mobile phone 1 of this embodiment, the third operating load, by which the mobile phone is returned from the state shown in FIGS. 1E and 1F to the first degree of opening shown in FIG. 1D, is further set to be heavier than the second operating load. For example, the third operating load is set to be several to several tens times as heavy as the first operating load described before.

In this case, referring to FIGS. 2A and 2B, the structure of the hinge mechanism 10 of the mobile phone 1, which has been explained in FIGS. 1A to 1F, will be explained below. In general, the hinge mechanism is composed of a shaft pin, which becomes a rotary shaft, and a cylindrical portion (barrel) into which this shaft pin is inserted. The hinge mechanism 10 of the mobile phone 1 includes: a cylindrical portion 14 having a pin hole 13 provided in the lower portion of the first casing 11; and a cylindrical portion 16 having a pin hole 15 provided in the upper portion of the second casing 12. The first casing 11 has two cylindrical portions 14, and the second casing 12 has three cylindrical portions 16 which interpose the cylindrical portions 14 from both sides.

The first casing 11 is inserted into the second casing 12 so that the cylindrical portions 14 can be located in the gaps 19 formed by the cylindrical portions 16 and so that the pin hole 13 and the pin hole 15 can be overlapped with each other. In the above state, the lock member 20, which is a rotary shaft of the hinge mechanism 10, is inserted into the pin hole 15 from the outside. Therefore, the lock member 20 functions as a shaft pin. The lock member 20 includes: a movable portion 21 fixed to the pin hole 15 of the second casing 12; a stationary portion 22 fixed to the pin hole 13 of the first casing 11; and an engaging protrusion 23 for fixing the lock member 20 to the first casing 11 so that the lock member 20 can not be disconnected from the first casing 11.

When the lock member 20 is attached to the hinge mechanism 10, the first casing 11 can be rotated round the lock member 20 with respect to the second casing 12. Although not shown in the drawing, a torsion coil spring is built in this lock member 20. An operating load to be given when the folded mobile phone 1 is opened and an operating load to be given when the folded mobile phone 1 is closed are determined by a torsional force generated by this torsion coil spring. This lock member 20 is widely used for the folding type mobile phone and the structure is well known. Therefore, further detailed explanations are omitted here.

On the other hand, in this embodiment, the lock pin 30 is provided on each side which continues to each end face on the outside of the cylindrical portion 14 of the first casing 11. Therefore, these lock pins 30 are arranged on both sides of the first casing 11. As shown in FIG. 2B, each lock pin 30 is protruded from the flange 31, and the forward end portion of the lock pin 30 is protruded from the first casing 11. The flange 31 is pushed by the compression spring 32 provided in the first casing 11. When the lock pin 30 is pushed from the outside by a strong force, the compression spring 32 is contracted and sunk into the first casing 11.

Further, the lock grooves 17 for receiving and locking the lock pins 30 are provided on the faces of the sides of the second casing 12 in portions opposed to the lock pins 30 in such a manner that the faces continue to the inner faces of the two outside cylindrical portions 16 among the three cylindrical portions 16 of the second casing 12. In this embodiment, when the first casing 11 and the second casing 12 are opened from each other by the angle 180°, the lock pins 30 provided in the first casing 11 are fitted into the lock grooves 17 of the second casing 12.

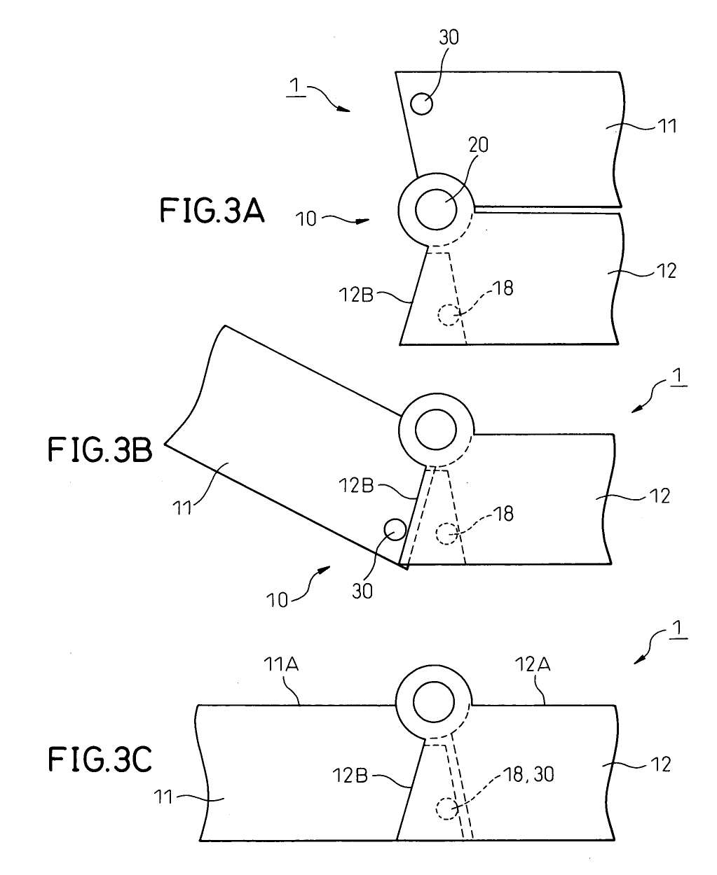

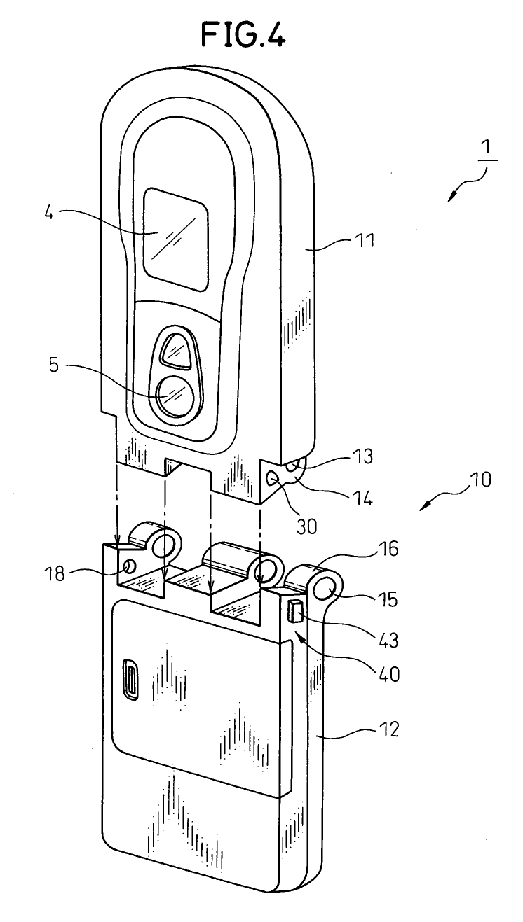

In the embodiment shown in FIGS. 2A and 2B, the lock groove 17, the cross section of which is an arc-shape, is provided in a portion opposed to each lock pin 30 of the second casing 12. However, instead of the lock groove 17, the lock hole 18, which is a circular hole, may be provided as shown in another embodiment illustrated in FIG. 4. Next, referring to FIGS. 3A to 3C, the locking motion conducted by the hinge mechanism 10 will be explained below. In FIGS. 3A to 3C, not the lock groove 17 is not shown but the lock hole 18 is shown.

FIGS. 3A to 3C are partially enlarged sectional views showing the operation of the hinge mechanism 10 of the mobile phone 1 explained before by referring to FIGS. 2A and 2B. FIG. 3A shows a state in which the mobile phone 1 is folded. At this time, the lock pin 30 is separate from the second casing 12. The aforementioned lock member 20 is fitted into the hinge mechanism 10.

When the first casing 11 is opened from the state shown in FIG. 3A with respect to the second casing 12, the first casing 11 is temporarily fixed to the second casing 12 by the lock member 20 in the state shown in FIG. 3B, that is, the first casing 11 is temporarily fixed to the second casing 12 by the lock member 20 in the state in which the first casing 11 is opened with respect to the second casing 12 by the angle 160°. In this state, the lock pin 30 provided in the first casing 11 comes into contact with the collision portion 12B of the second casing 12.

In order to further open the first casing 11 with respect to the second casing 12 from this state, it is necessary for the lock pin 30 to be pushed into the first casing 11 by the collision portion 12B and it is also necessary for the lock pin 30 to slide on the side of the casing 12 while the lock pin 30 is being pushed into the first casing 11. Therefore, the operating load necessary for further opening the first casing 11 with respect to the second casing 12 from the state shown in FIG. 3B to the state shown in FIG. 3C is heavier than the operating load necessary for opening the first casing 11 with respect to the second casing 12 from the state shown in FIG. 3A to the state shown in FIG. 3B.

When the first casing 11 is opened with respect to the second casing 12, by providing a large operating load, at the point of time when the lock pin 30 gets into the lock hole 18 as shown in FIG. 3C, the first casing 11 can not be opened anymore with respect to the second casing 12. In this state, the information displaying face 11A of the first casing 11 and the input operating face 12A of the second casing are located on the same plane. Therefore, even if this mobile phone is a folding type mobile phone 1, it is possible for a user to use this mobile phone 1 as a rod-shaped mobile phone without feeling a sense of incongruity.

In order to disconnect the lock pin 30 from the lock hole 18 under the condition that the lock pin 30 is fitted into the lock hole 18, it is necessary to give a strong force (a high intensity torque). Therefore, the first casing 11 and the second casing 12 are locked to each other under the condition that the first casing 11 and the second casing 12 are opened from each other by the angle 180°. As a result, even in the case of a folding type mobile phone, when the first casing 11 and the second casing 12 are once opened by the angle 180°, the folding type mobile phone can be used in the same manner as that of the rod-shaped mobile phone.

In this connection, by devising the shape of the collision portion of the second casing 12 and also by devising the shapes of the lock hole 18 and the lock pin 30, the operating load necessary for returning the first casing 11 from the lock state to the first degree of opening can be made to be heavier than the operating load necessary for locking the first casing 11 and the second casing 12 to each other in the lock state in which the first casing 11 is opened with respect to the second casing 12 by the angle 180°. For example, when the contacting portion of the lock pin 30 of the collision portion 12B of the second casing 12 is tapered or curved, the lock pin 30 can easily move over the collision portion 12B. At the same time, the inner circumferential face of the lock hole 18 may be formed into a cylindrical shape with respect to the side of the second casing 12, so that the lock pin 30 can not be easily disconnected from the lock hole 18.

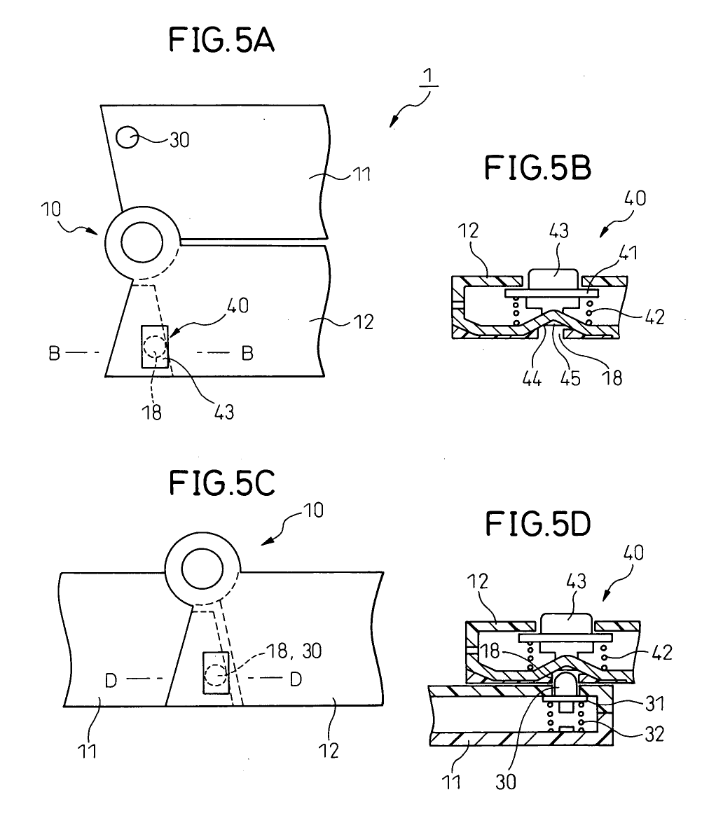

On the other hand, in order for the mobile phone 1, which is difficult to fold because the lock pin 30 is fitted into the lock hole 18, to be easily folded, as shown in another embodiment illustrated in FIG. 4, it is necessary to provide a lock release mechanism 40 for releasing the engagement of the lock pin 30 with the lock hole 18 as shown in the drawing. This lock release mechanism 40 will be explained by referring to FIGS. 5A to 5D.

FIGS. 5A to 5D are views showing the structure of the lock release mechanism 40 shown in FIG. 4. FIG. 5A is a partial side view of the mobile phone 1 which is closed, and FIG. 5B is a partial sectional view taken on line B-B in FIG. 5A. FIG. 5C is a partial side view of the mobile phone 1 which is completely opened, and FIG. 5d is a partial sectional view taken on line D-D in FIG. 5C.

As shown in FIG. 5B, the lock release mechanism 40 includes: a flange 41 provided in the second casing 12; a button 43 which is protruded from the flange 41 and the forward end portion of which is protruded from the second casing 12; a compression spring 42 for pushing the flange 41; and a pushing portion 45 protruded from the face opposite to the button 43 of the flange 41. On the lower side of the flange 41, the stopper 44 is provided which restricts the button 43 from being excessively sunk into the second casing 12.

When the mobile phone 1 is opened from the state shown in FIG. 5A to the state shown in FIG. 5C, the lock pin 30 protruding onto the side of the first casing 11 enters the lock hole 18 provided in the second casing 12. In this state, in order to disconnect the lock pin 30 from the lock hole 18 and fold the first casing 11 with respect to the second casing 12, a heavy operating load is needed as described before. In this case, when the button 43 of the lock release mechanism 40 is pushed into the second casing 12, the pushing portion 45 enters the lock hole 18. Then, the lock pin 30, which is located in the lock hole 18, is pushed out from the lock hole 18, while resisting a force generated by the spring 32. As a result, the lock pin 30 is disconnected from the lock hole 18, and the first casing 11 can be folded with respect to the second casing 12 by a low intensity of force.

The portion of the second casing 12 with which the lock pin 30 comes into contact, the face (the portion surrounded by the broken line in FIG. 3) of the second casing 12 on which the contracted lock pin 30 slides, or the lock pin 30 itself can be made of a wear proof material. In this case, the feeling on operating (opening and closing) the first casing 11 with respect to the second casing 12 between the angels 160° and 180° can be maintained to be good over a long period of time. Examples of the wear proof material are engineering plastics such as polyacetal and others.

Explanations are made above into a mobile phone which is an example of the information processing unit. However, it should be noted that the information processing unit is not limited to a mobile phone, that is, there are various types of information processing units.

What is claimed is:

1. An information processing unit, which is opened from a folded state when it is used, comprising:
a first and a second casing connected to each other by a hinge mechanism;
a first fixing mechanism arranged in the hinge mechanism, for temporarily fixing the first and the second casing by a predetermined holding force when an opening angle formed between the first and the second casing is a predetermined angle smaller than 180°; and
a second fixing mechanism arranged in the hinge mechanism, for locking the first and the second casing by a stronger holding force than the holding force of the first fixing mechanism under the condition that the opening angle formed between the first and the second casing is 180°.

2. An information processing unit according to claim 1, wherein a first operating load for opening the first and the second casing from the closed state to the temporarily fixed state is set in the hinge mechanism, and a second operating load, which is heavier than the first operating load, for opening the first and the second casing from the temporarily fixed state to the lock state is also set in the hinge mechanism.

3. An information processing unit according to claim 2, wherein a third operating load, which is heavier than the second operating load, for returning the first and the second casing from the lock state to the temporarily fixed state is set in the hinge mechanism.

4. An information processing unit according to claim 1, wherein the hinge mechanism is composed so that an information display face of the first casing and an input operating face of the second casing can be positioned on the same plane when the first and the second casing are opened by the angle of 180°.

5. An information processing unit according to claim 1, wherein the predetermined angle is 160° to 170°.

6. An information processing unit according to claim 1, wherein the first fixing mechanism is composed of a lock member, which is a rotary shaft of the first and the second casing, attached to the hinge mechanism.

7. An information processing unit according to claim 6, wherein the lock member includes a stationary portion engaged with the first casing, a movable portion engaged with the second casing and a torsion coil spring provided between the stationary portion and the movable portion, and
the stationary portion and the movable portion are temporarily fixed to each other by the predetermined holding force when an opening angle between the first casing and the second casing is set at the predetermined angle.

8. An information processing unit according to claim 1, wherein
the second fixing mechanism includes a lock pin, which is provided in one of the first and the second casing, and a lock hole,
the lock pin is pushed by a spring and protruded from the casing and sunk in the casing when an external force is given to the lock pin, and
the second fixing mechanism conducts a locking action when the lock pin enters the lock hole.

9. An information processing unit according to claim 8, wherein
the hinge mechanism includes a lock release button for releasing the locking action conducted by the second fixing mechanism, and the locking action conducted is released when the lock release button is pushed.

10. An information processing unit according to claim 8, wherein
the lock pin comes into contact with a collision portion provided in the other casing when the stationary portion and the movable portion are temporarily fixed to each other.

11. An information processing unit according to claim 10, wherein
a portion of the collision portion coming into contact with the protrusion is made of material having a lubricating property.

12. An information processing unit according to claim 11, wherein
a bottom face portion of the casing, which continues to the collision portion, on which the lock pin slides when the first and the second casing are transferred from the temporarily fixed state to the lock state, is made of material having a lubricating property.

13. An information processing unit according to claim 12, wherein
the material having a lubricating property is an engineering plastic.

14. An information processing unit according to claim 13, wherein
the engineering plastic is polyacetal.

15. An information processing unit according to claim 1, wherein
the information processing unit is a mobile phone.
